(19) United States
(12) Patent Application Publication
(10) Pub. No.: US 2017/0261526 A1
(43) Pub. Date: Sep. 14, 2017

(54) QUALITY CONTROLS OF ANALYZERS FOR BIOLOGICAL SAMPLES

(71) Applicant: Roche Diagnostics Operations, Inc., Indianapolis, IN (US)

(72) Inventors: Andreas Calatzis, Rotkreuz (CH); Felix Dross, Kirchhain (DE)

(21) Appl. No.: 15/450,567

(22) Filed: Mar. 6, 2017

(30) Foreign Application Priority Data
Mar. 10, 2016 (EP) 16159744.8

(51) Int. Cl. G01N 35/00

(52) U.S. Cl. CPC G01N 35/00623

(57) ABSTRACT

A method for monitoring the performance of an analyzer for biological samples having an automated preparation device is presented. The method comprises receiving an instruction that a monitoring procedure shall be executed, after receipt of the instruction that a monitoring procedure shall be executed, obtaining, by the automated preparation device, at least two quality control ingredients from a repository including a plurality of quality control ingredients, and mixing, by the automated preparation device, the at least two quality control ingredients in a sample preparation receptacle to obtain a quality control which mimics the properties of a biological sample to be analyzed by the analyzer. The method further comprises determining at least one parameter of the quality control and determining a status of the analyzer based on the determined parameter of the quality control.

### CROSS-REFERENCE TO RELATED APPLICATIONS

This application claims priority to EP 16159744.8, filed Mar. 10, 2016, which is hereby incorporated by reference.

### BACKGROUND

The present disclosure relates to methods for monitoring the performance of an analyzer for biological samples and automated analyzers for biological samples.

Automated, or semi-automated, analyzers for biological samples are employed in a variety of clinical or laboratory settings. Frequently, the results of the measurements performed by such automated, or semi-automated, analyzers can form the basis of medical decisions, e.g., diagnostic and/or therapeutic decisions of a medical practitioner. Therefore, automated, or semi-automated, analyzers usually have to undergo rigorous quality control procedures.

One example of such analyzers are devices for performing in vitro diagnostic (IVD) methods which are widely applied, e.g., to assist in diagnosing diseases or for monitoring the effect of treatments. In IVD devices (as well as in other automated, or semi-automated, analyzers for biological samples) quality controls are inserted periodically, or in response to predetermined trigger events. These quality controls can mimic a particular type of biological sample. Quality controls can be obtained by either using an actual, or artificial, biological sample of the particular type with known properties. For instance, a quality control for an IVD device might consist in a quantity of blood or plasma from a healthy individual. In other examples, a quality control for an IVD device might consist in a quantity of blood or plasma from a healthy individual into which a particular substance, e.g., a drug or a metabolite of a drug, has been added.

Unfortunately, many bodily substances have a fairly limited shelf life. Consequentially, quality controls are, in some examples, prepared and frozen, or freeze-dried, at a vendor's site, shipped to a particular laboratory and then thawed, or reconstituted, shortly before they are used in a monitoring procedure.

The number of different types of quality controls required for properly monitoring the operation of particular automated, or semi-automated, analyzers for biological samples (e.g., an IVD device) can be fairly large. For instance, each particular assay of an automated, or semi-automated, analyzers might require one or more (e.g., “normal,” “lightly abnormal” and “strongly abnormal”) quality controls. Handling this number of quality controls (particularly in a just-in-time manner) can be fairly complex. In particular, preparing, including, e.g., freeze-drying, a number of different types of quality controls can be expensive. In addition, manually reconstituting the quality controls before use can be fairly time consuming, tedious and prone to errors.

As a consequence, carrying out required, or desired, monitoring procedures for automated, or semi-automated analyzers, for biological samples can bind a substantial amount of resources in a typical laboratory handling biological samples.

### SUMMARY

According to the present disclosure, a method for monitoring the performance of an analyzer for biological samples having an automated preparation device is presented. The method can comprise receiving an instruction that a monitoring procedure shall be executed; after receipt of the instruction that a monitoring procedure shall be executed, obtaining, by the automated preparation device, at least two quality control ingredients from a repository including a plurality of quality control ingredients, and mixing, by the automated preparation device, the at least two quality control ingredients in a sample preparation receptacle to obtain a quality control which mimics the properties of a biological sample to be analyzed by the analyzer. The method also can comprise determining at least one parameter of the quality control and determining a status of the analyzer based on the determined parameter of the quality control.

Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a schematic representation of different quality controls that can be generated by using quality control ingredients from a quality control ingredient repository according to an embodiment of the present disclosure.

FIG. 2 illustrates a schematic representation of an analyzer including an assembly adapted to prepare quality controls according to an embodiment of the present disclosure.

FIG. 3 illustrates a schematic representation of another analyzer including an assembly adapted to prepare quality controls according to an embodiment of the present disclosure.

FIGS. 4a-10 illustrate flow diagrams illustrating different methods for preparing quality controls according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A method for monitoring the performance of an analyzer for biological samples having an automated preparation device is presented. The method can comprise receiving an instruction that a monitoring procedure shall be executed; after receipt of the instruction that a monitoring procedure shall be executed, obtaining, by the automated preparation device, at least two quality control ingredients from a repository including a plurality of quality control ingredients, and mixing, by the automated preparation device, the at least two quality control ingredients in a sample preparation receptacle to obtain a quality control which mimics the properties of a biological sample to be analyzed by the analyzer. The method can further comprise determining at least one parameter of the quality control and determining a status of the analyzer based on the determined parameter of the quality control.

A method for monitoring the performance of an analyzer for biological samples having an automated preparation device including: receiving an instruction that a monitoring procedure shall be executed, upon receipt of the instruction that a monitoring procedure shall be executed, by the automated preparation device, obtaining one or more matrix solutions from a repository including a plurality of quality control ingredients, obtaining one or more modifying agents from the repository including a plurality of quality control ingredients and mixing at least the one or more matrix solutions and the one or more modifying agents in a sample preparation receptacle to prepare a quality control sample which mimics the properties of a biological sample to be analyzed by the analyzer is presented. The method can further comprise determining at least one parameter of the quality control sample and setting a status of the analyzer to a fault state if the at least one parameter deviates from a target parameter range.

An automated analyzer for analyzing biological samples is presented. The automated analyzer can comprise a repository for storing a plurality of quality control ingredients for preparing quality controls, an automated preparation device configured to, after receipt of the instruction that a monitoring procedure shall be executed, obtain at least two quality control ingredients from the repository including a plurality of quality control ingredients and mix the at least two quality control ingredients in a sample preparation receptacle to obtain a quality control which mimics the properties of a biological sample to be analyzed by the analyzer and a measurement device configured to determine at least one parameter of the quality control and to determine a status of the analyzer based on the determined parameter of the quality control.

The methods and the apparatus can have one or more of the following advantages in some embodiments.

Firstly, quality controls can be prepared directly in an analyzer whose performance can be monitored (or in a laboratory housing this analyzer). This can reduce the number of quality controls to be shipped to, stored at and eventually reconstituted in a laboratory hosting one or more analyzers to be monitored. In some examples, the quality controls can be freeze-dried and then shipped to a destination laboratory in a freeze-dried form. Before use at the destination laboratory, the freeze-dried quality controls have to be reconstituted, which can be a relatively labor and time-intensive and error-prone process. In some examples, the techniques of the present disclosure can supersede handling freeze-dried quality controls (or at least reduce the number of freeze-dried items to be handled). This can free a substantial amount of resources in the laboratory environment.

Secondly, the quality controls can be prepared by a preparation device of the analyzer. For instance, some analyzers include a pipettor or other liquid handling unit adapted to automatically prepare samples according to a predefined recipe. Such pipettor can be used when employing the disclosed techniques to prepare quality controls for monitoring processes of the analyzer. In this manner, these techniques can allow for a more efficient usage of laboratory equipment.

Thirdly, automatic preparation devices of analyzers (e.g., pipettors) can be fairly precise in some examples. This can improve the quality and reproducibility with which quality controls can be produced in the analyzer compared to the manual reconstitution of freeze-dried controls by the user.

Fourthly, the quality controls can be prepared on demand when using the disclosed techniques in some examples (e.g., directly before they are used in a performance monitoring procedure). This can reduce a period of storage of the quality controls. As many quality controls are not stable for an extended period of time, this can make handling quality more efficient and less costly.

Fifthly, a limited set of quality control ingredients can be used to prepare a variety of different quality controls in some examples. For instance, blood serum or blood plasma (i.e., a particular matrix) can be used as matrix for a large variety of quality controls for assays operating on blood serum or blood plasma samples. In the same manner, a particular drug metabolite (i.e., a modifying agent) can be used to prepare different levels of quality controls or can be combined with different matrices. This can reduce a number of items which have to be handled (e.g., supplied, stocked and reconstituted) in a laboratory.

Sixthly, the quality control ingredients can be stored in a liquid form (or in a different precursor form) that can have a comparatively long shelf-life compared to the quality controls prepared from the quality control ingredients. For example, blood serum or blood plasma samples to which modifying agents have been added or which have been diluted may not be stable for a long time. In some examples, these matrices can include proteins whose effect can be impaired by added substances or dilution, and/or the added substances may be impaired, e.g. chemically transformed, by some matrix components. This can mean that these quality controls can be stored in their ready-to-use form only for a fairly limited amount of time. As a consequence, quality controls are stored in a freeze-dried form in some prior-art solutions. As discussed above, this can require fairly complex equipment and processes. At least some of the disclosed quality control ingredients, on the other hand, can be stored in liquid form. Thus, when using the disclosed techniques, in some examples, stock-keeping of quality controls can be simplified.

Seventhly, the quality control ingredients can handled in a similar manner as reagents used in the analyzers for performing analytical tests. For instance, the quality control ingredients can be prepared in disposable cassettes or containers which can be easy to handle outside and inside an analyzer.

Eighthly, the disclosed techniques can be carried out in a completely automated fashion in some examples. An analyzer merely has to be stocked with a selected number of quality control ingredients and can then prepare quality controls for a large variety of performance monitoring procedures automatically. In particular, given the number of quality control ingredients, a larger number of quality controls can be at least in some cases prepared than the number of the quality control ingredients. This can be achieved for example by combining different quality control ingredients together and/or different amounts to obtain respective different concentrations of quality control ingredients, according to the particular need, thus eliminating the need to have all possible ready-to-use or ready-to-reconstitute quality controls in advance.

The term ‘quality control’ can refer to any substance or composition that can be used to monitor the performance of an analyzer for biological samples. The term ‘quality control’ can refer to a physical sample used in one or several monitoring processes to monitor the performance of particular tests or assays of the analyzer. For instance, such test or assay can be a determination of a thrombin clotting time in which the time it takes can be measured for a clot to form in the plasma of a blood sample containing anticoagulant after an excess of thrombin has been added. In this test, a quality control can include blood plasma as a first quality control ingredient (matrix) and thrombin as a second quality control ingredient.

The same particular quality control can be used to monitor the performance of a plurality of tests or assays of an analyzer in some examples. On the other hand, monitoring the performance of a particular test or assay of any analyzer may include different types of quality controls.

The term ‘quality control’ does not include reference samples the analyzer may prepare from a biological sample to be analyzed.

The term ‘monitoring procedure’ can include any process for monitoring the performance of a particular test (or a particular assay) an analyzer can perform on a biological sample. These tests or assays can include any clinical or laboratory test or assay on biological samples an analyzer may perform. A monitoring procedure can include determining one or more parameters of one or more quality controls.

A variety of tests or assays will be listed subsequently for the sake of illustration. In the preceding paragraphs, a thrombin clotting time test or assay has been mentioned. In this example, one or more parameters of one or more quality controls mimicking a biological sample used in the thrombin clotting time test or assay can be determined as part of the monitoring procedure. In other examples, a test or assay can be a prothrombin time (‘PT’) test or assay evaluating an extrinsic pathway of coagulation. In still other examples, a test or assay can include partial thromboplastin time (‘PTT’) test or assay or an activated partial thromboplastin time (‘aPTT’ or ‘APTT’) being another medical test that characterizes blood coagulation. In still other examples, a test or assay can determine levels of fibrinogen, antithrombin, a von Willenbrand factor, a D-Dimer, rivaroxaban, heparin, dabigatran, a blood clotting protein (e.g., factor VIII or factor IX). In still other examples, a test or assay can determine a level of a drug or a drug metabolite, or a disease marker.

In still other examples, a test or assay can be adapted to detect an allergy marker (e.g., a particular antibody), an anemia marker (e.g., ferritin, folate or vitamin B12), a dependence causing substance (e.g., an amphetamine, a barbiturate, a benzodiazepine, a cannabinoid, cocaine, ethanol, lysergic acid diethylamide, methadone, methaqualone, an opiate, oxycodone, phencyclidine, propoxyphene), or a metabolite of the preceding dependence causing substances, an enzyme (e.g., ACP, ALT/GPT, ALP, a pancreatic enzyme, AST(GOT, cholinesterase, CK, CK-MB, GGT, GLDH, HBDH, lactate, or lipase), a growth hormone, a glycated hemoglobin, an immunosuppressant (e.g., cyclosporine, MPA, tacrolimus), an inflammation marker (e.g., anti-CCP), a specific protein (e.g., ALB, A1MG, ASLO, APOA, APOB, CERU, C3c, C4, CRP, hsCRP, CYSC, FERR, HAPT, IgA, IgG, IgM, KAPPA, LAMBDA, LPA, MYO, PREA, RF, STfR, TRANS, AAGP, AAT, or B2MG), a substrate (e.g., albumin, ammonia, CO₂, bilirubin, blood urea nitrogen, calcium, cholesterol, creatinine, fructosamine, HDL cholesterol, homocysteine, iron, LDH, magnesium, phosphorus, tryglyceride, or uric acid), a therapeutic drug (e.g., acetaminophen, cyclosporine, MPA or tacrolimus), a thyroid hormone or protein (e.g., anti-TSHT, anti-Tg, anti-TPO, calcitonin, FT3, FT4, Tg, TSH, T4, or T3), a thyroid autoimmune disease marker (e.g., anti-TSHR, anti-Tg, or anti-TPO), or a thyroid cancer marker (e.g., calcitonin or Tg).

Further example tests or assays of analyzers for whose performance monitoring quality controls can be prepared by the disclosed techniques are discussed below.

The term ‘quality control ingredient’ can include any substance that can be a constituent of a quality control to be used to monitor the performance of a particular test of an analyzer for biological samples.

In one example, quality control ingredients can include a matrix (e.g., a matrix solution). These matrices can be derived from a bodily fluid or a constituent of a bodily fluid. In other examples, the matrix (e.g., matrix solution) can be an artificial substance which mimics properties of a bodily fluid or of a constituent of a bodily fluid. In some examples, the matrix (e.g., matrix solution) can include blood, saliva, ocular lens fluid, cerebrospinal fluid, sweat, urine, stool, semen, milk, ascites fluid, mucous, synovial fluid, peritoneal fluid, amniotic fluid, tissue, cultured cells, or constituents of these bodily substances. In other examples, the matrix can include a concentrated or diluted form of these bodily substances.

In one example, a matrix solution can be blood plasma or blood serum. In one example the matrix solution can be freeze-dried. In one example, only the matrix solution among the quality control ingredients can be freeze-dried.

In addition or alternatively, quality control ingredients can include modifying agents (also referenced as ‘modifiers’). In some examples, a modifying agent can include one or more of a drug, a metabolite of a drug, a substance that accumulates in a predetermined medical or metabolic condition, a substance that is normally not present in a bodily fluid, and a substance that is normally present in a bodily fluid. For instance, a modifying agent can be heparin, hirudin, rivaroxaban, dabigatran, D-dimer, prothrombin, drugs or drug metabolites, enzymes, growth hormones, immunosuppressants, proteins, inflammation markers, substrates such as albumin, bilirubin, creatinine and disease markers.

In addition or alternatively, quality control ingredients can include diluents. For instance, diluents can be water, salt solutions (e.g., saline solutions).

In addition or alternatively, quality control ingredients can include stabilizers. In general, stabilizers can improve a stability of quality controls (e.g., a quality control including a particular matrix solution and one or more modifying agents). For instance, a stabilizer can be albumin, gelatin, a sugar or a salt.

In addition or alternatively, quality control ingredients can include reagents. The term ‘reagent’ can refer to a substance which can be added to a biological sample when performing a particular test on the biological sample in the analyzer to elicit a particular reaction in the blood sample. The reagents can be specific for a particular test or assay (e.g., the tests or assays discussed above). For example, in a situation where a partial thromboplastin time of a blood sample can be determined, the analyzer can be configured to add an activator as reagent to the blood sample to activate the intrinsic pathway of coagulation. Particular substances can be ‘modifying agents’ or ‘reagents’ accord in different situations. In some examples, an analyzer may not add a reagent to a biological sample to be analyzed. Accordingly, a quality control may not include a reagent in some examples.

The terms ‘analyzer’/‘analytical work cell’/‘analytical unit’ as used herein can encompass any apparatus or apparatus component that can measure analytical properties of a biological sample, e.g., following a reaction of a biological sample with a reagent for obtaining a measurement value.

An analyzer can be operable to determine one or more parameters of a biological sample or a component thereof. For example, a parameter can be an absorption, transmittance or reflectance of the biological sample contained in a cuvette. In other examples, a parameter can be a fluorescence of a biological sample after having been illuminated with excitation light. Apart from the optical measurement devices of an analyzer discussed below (e.g., to determine an absorption, transmittance or reflectance), an analyzer can include measurement devices to determine a parameter of the sample via one or more chemical, biological, physical, or other technical procedures.

An analyzer may be operable to determine the parameter of the sample or of at least one analyte, process the determined parameter and return an obtained measurement value. The list of possible analysis results returned by the analyzer comprises, without limitation, concentrations of the analyte in the sample, a qualitative (yes or no) result indicating the existence of the analyte in the sample (corresponding to a concentration above the detection level), optical parameters, DNA or RNA sequences, data obtained from mass spectroscopy of proteins or metabolites and physical or chemical parameters of various types.

An analytical work cell may comprise units for pipetting, dosing, and mixing of samples and/or reagents. The analyzer may comprise a reagent holding unit for holding reagents to perform the assays. Reagents may be arranged for example in the form of containers or cassettes containing individual reagents or group of reagents, placed in appropriate receptacles or positions within a storage compartment or conveyor. It may comprise a consumable feeding unit. The analyzer may comprise a process and detection system whose workflow is optimized for certain types of analysis. Examples of such analyzers can be clinical chemistry analyzers, coagulation chemistry analyzers, immunochemistry analyzers, urine analyzers, hematology analyzers, nucleic acid analyzers, used to detect the result of chemical or biological reactions or to monitor the progress of chemical or biological reactions.

The term ‘biological sample’ can refer to material(s) that may potentially contain an analyte of interest. The biological sample can be derived from any biological source, such as a physiological fluid, including blood, saliva, ocular lens fluid, cerebrospinal fluid, sweat, urine, stool, semen, milk, ascites fluid, mucous, synovial fluid, peritoneal fluid, amniotic fluid, tissue, cultured cells, or the like. The biological sample can be pretreated prior to use, such as preparing plasma from blood. Methods of treatment can involve centrifugation, filtration, distillation, dilution, concentration and/or separation of sample components including analytes of interest, inactivation of interfering components, and the addition of reagents. A biological sample may be used directly as obtained from the source or used following a pretreatment to modify the character of the sample. In some embodiments, an initially solid or semi-solid biological material can be rendered liquid by dissolving or suspending it with a suitable liquid medium. In some examples, the sample can be suspected to contain a certain antigen or nucleic acid.

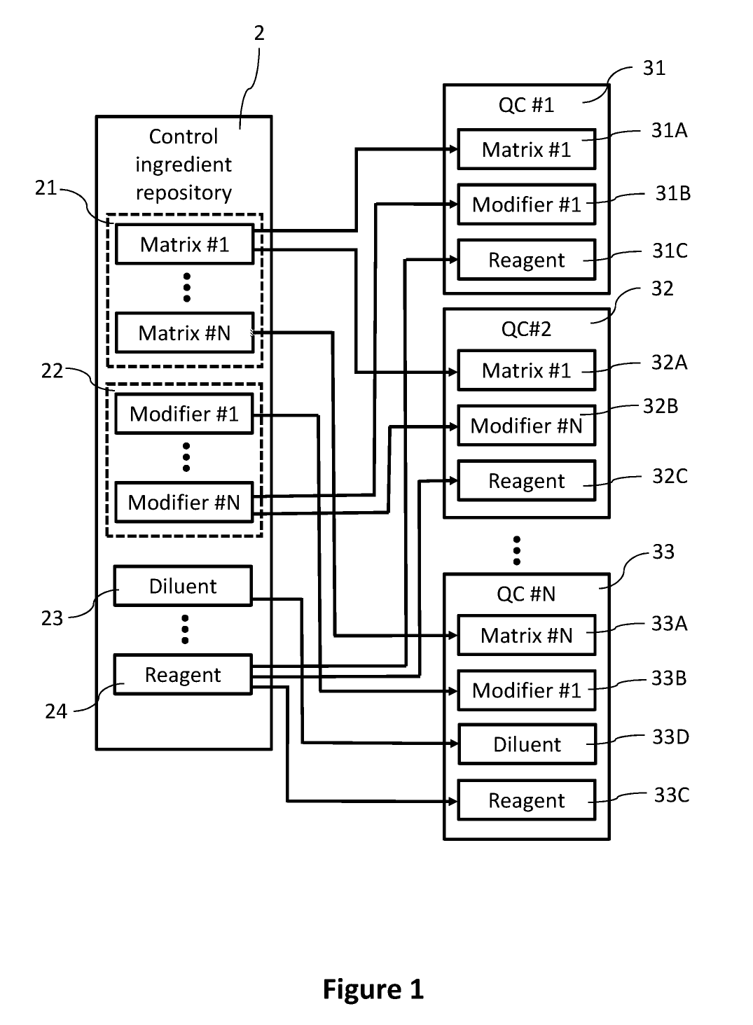

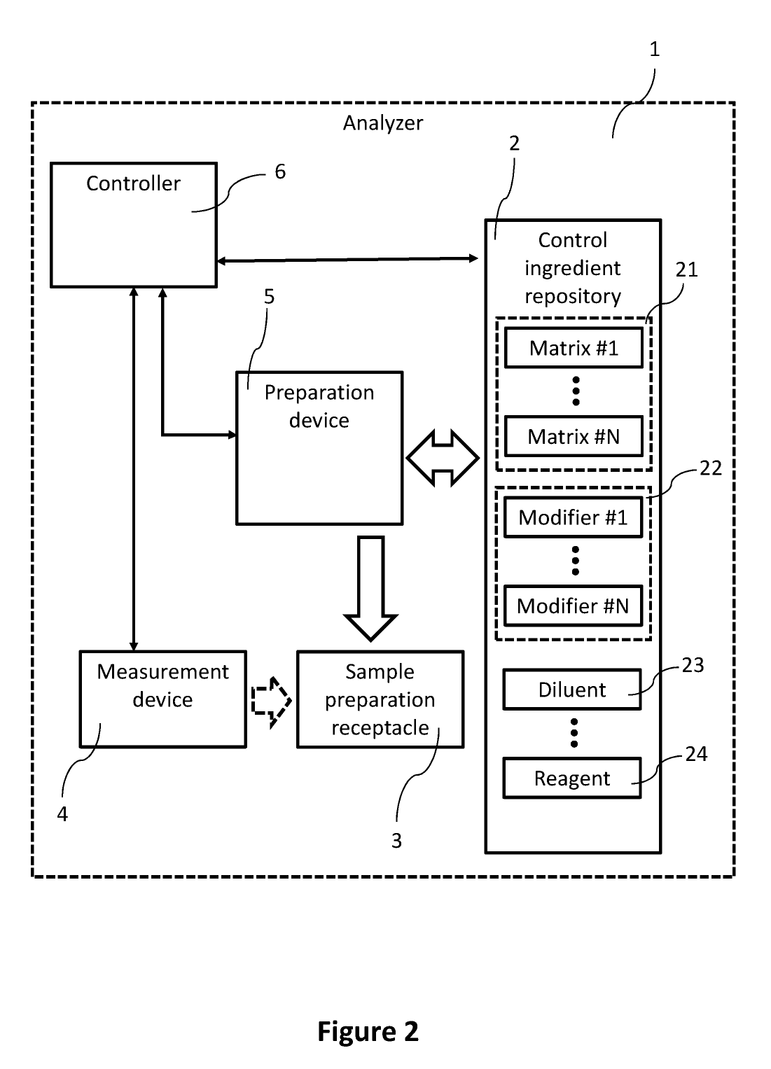

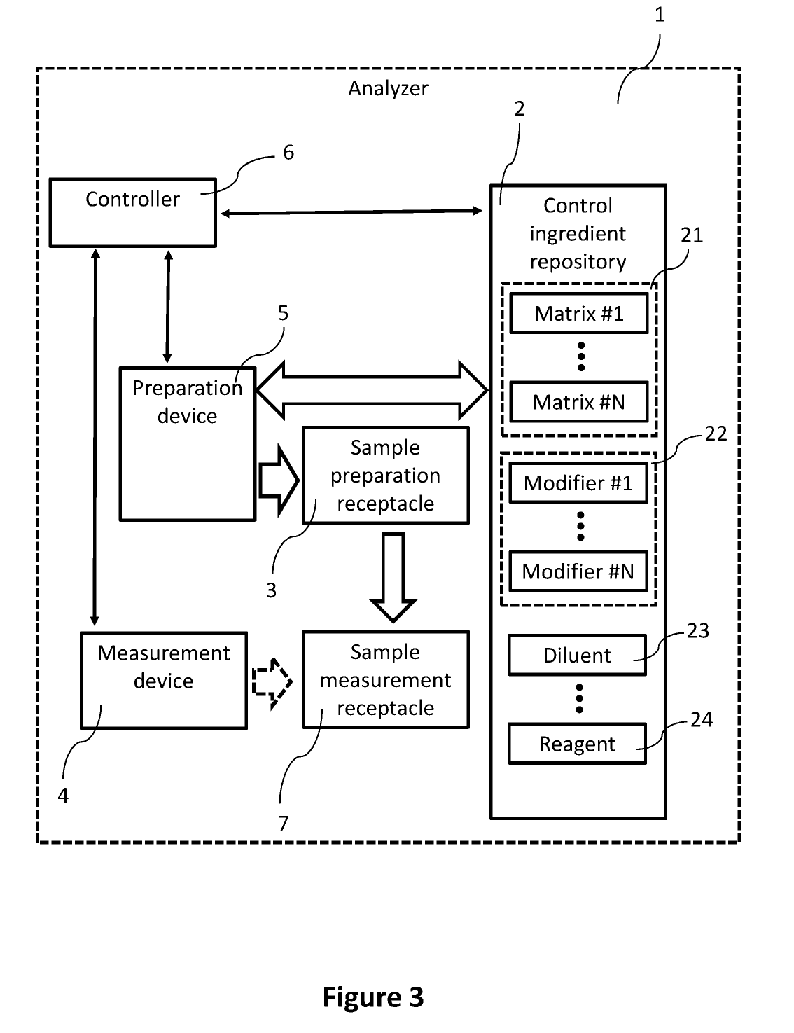

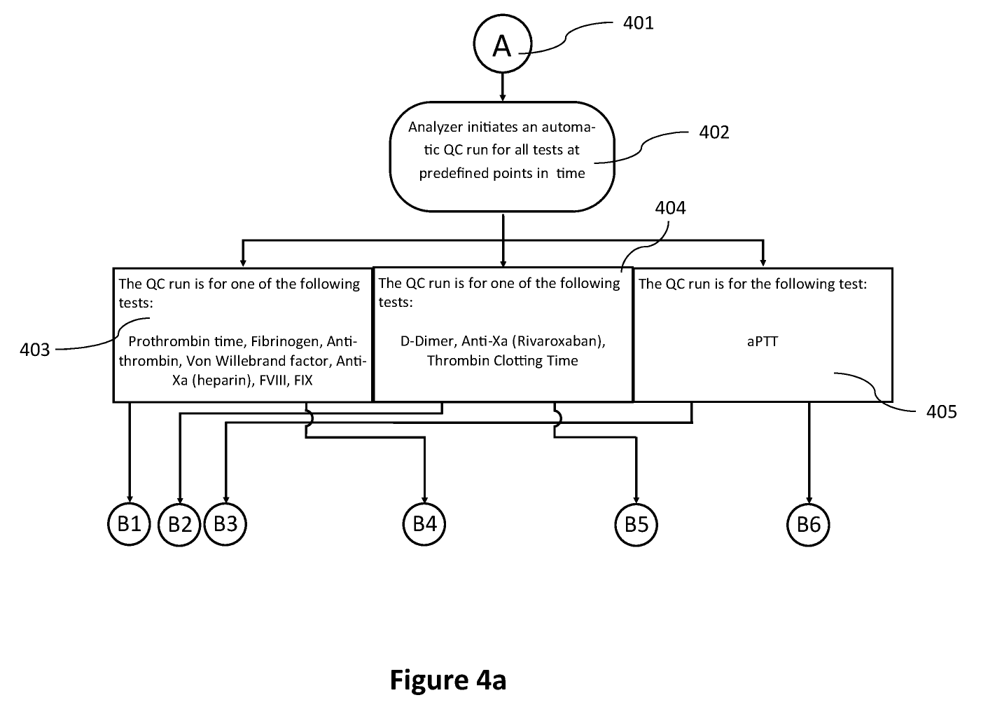

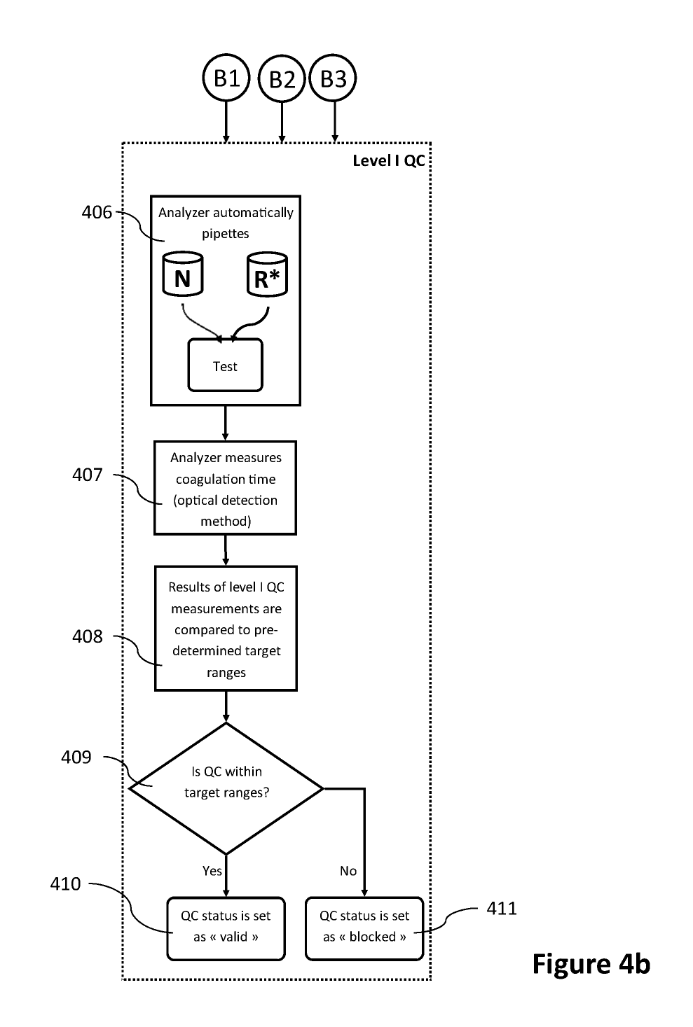

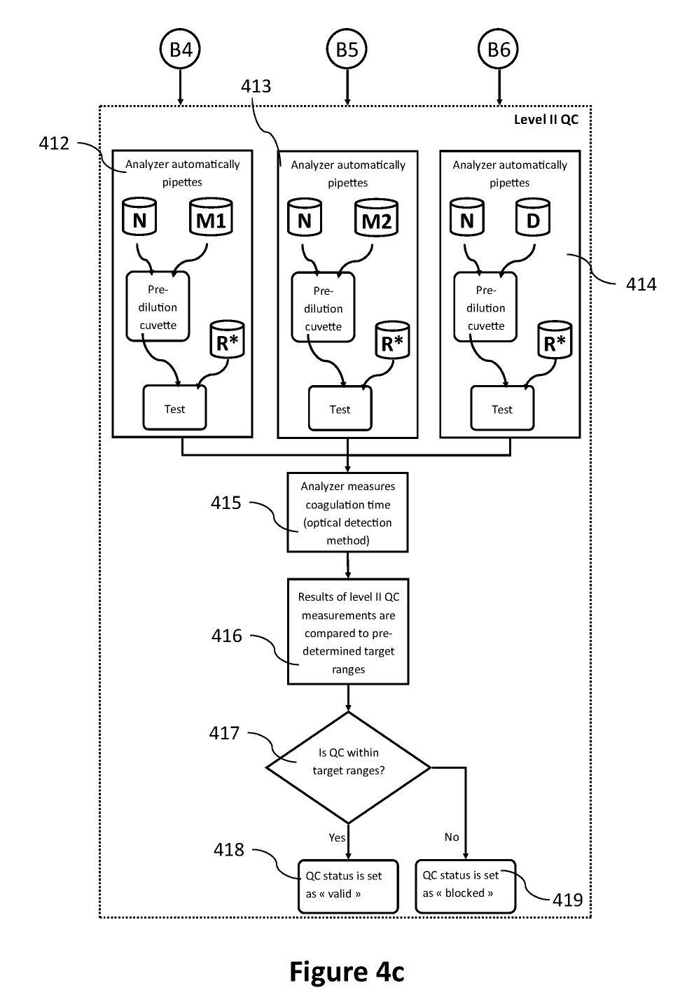

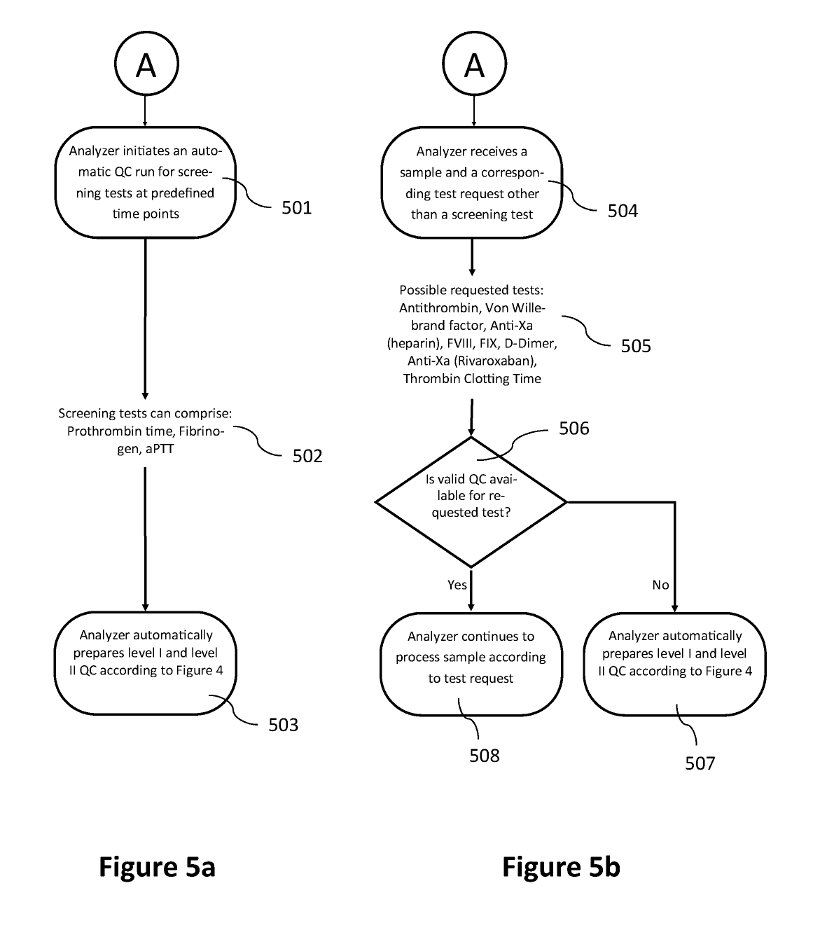

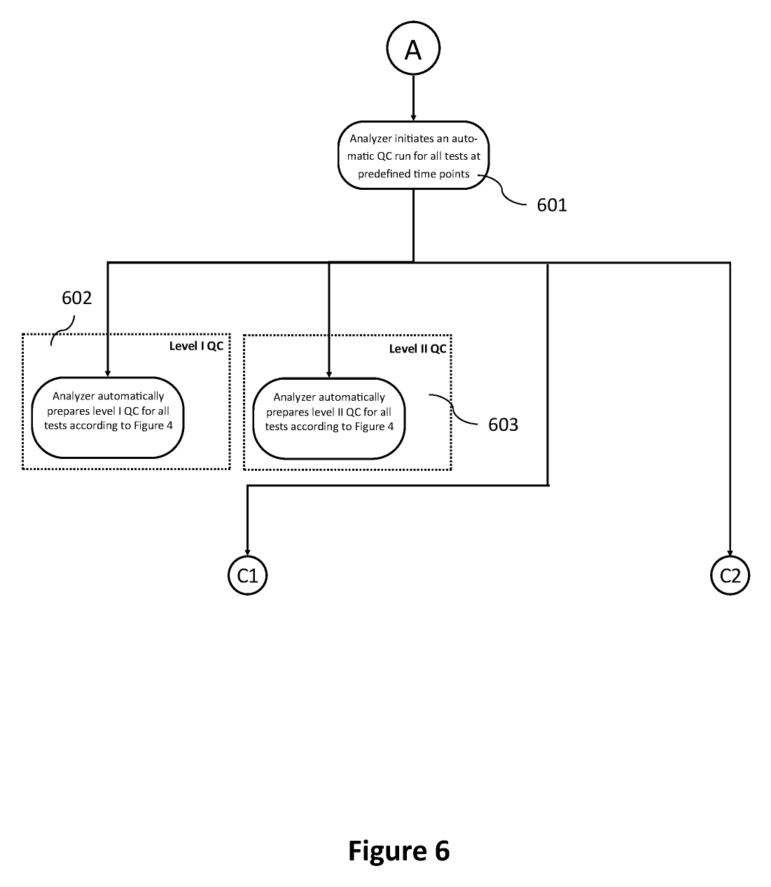

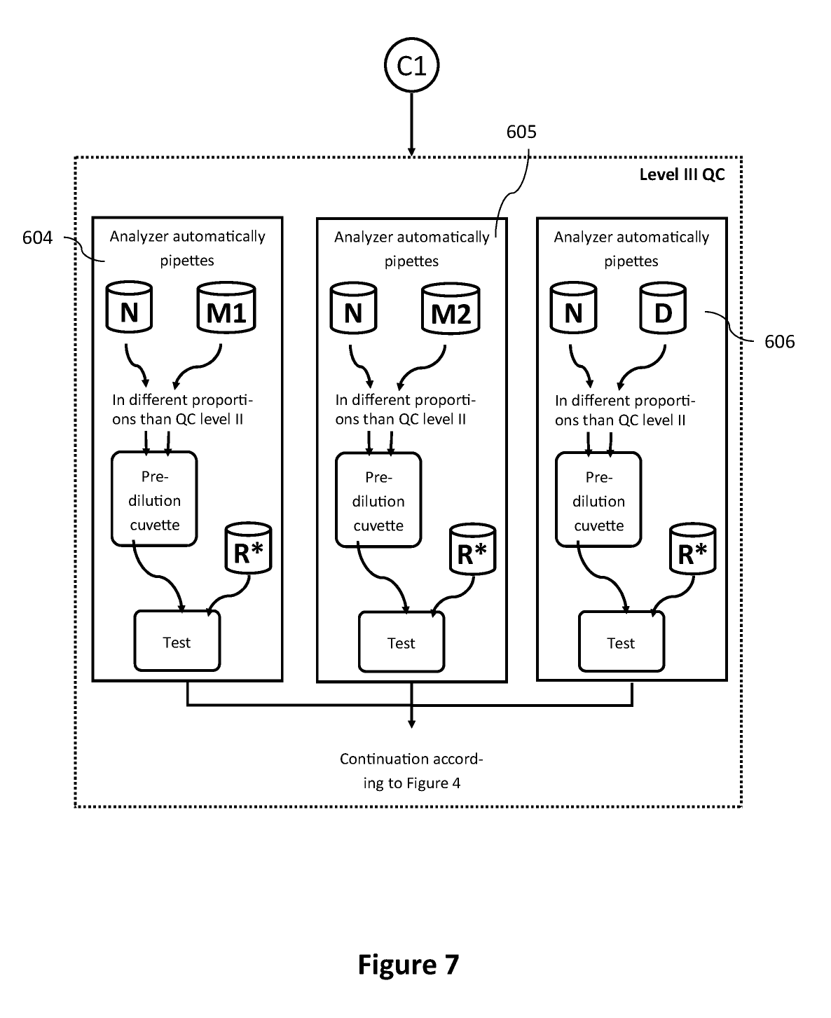

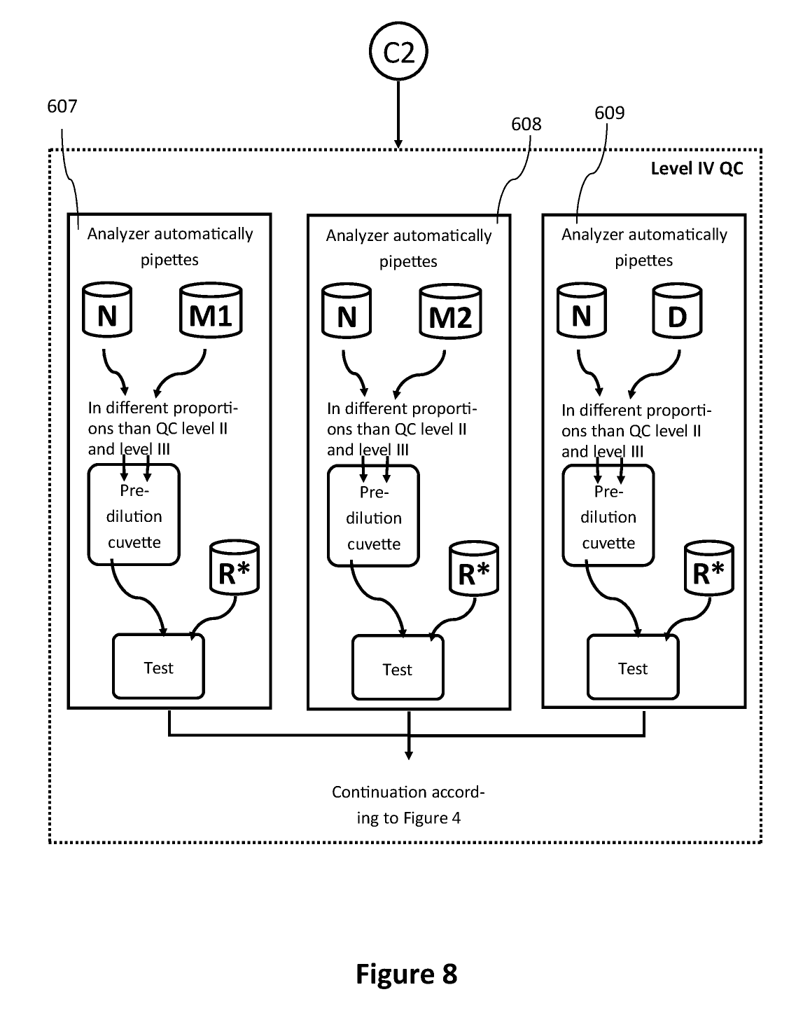

In connection with FIG. 1, the methods for monitoring the performance of an analyzer for biological samples can be discussed. Subsequently, in connection with FIG. 2 and FIG. 3, different aspects of automated analyzers having quality control preparation will be treated in more detail. Last, in connection with FIG. 4a to FIG. 10, it can be shown how the disclosed techniques can be used to implement complex quality control procedures.

FIG. 1 illustrates a method for monitoring the performance of an analyzer for biological samples having an automated preparation device including receiving an instruction that a monitoring procedure shall be executed, after receipt of the instruction that a monitoring procedure shall be executed, obtaining, by the automated preparation device, at least two quality control ingredients from a repository 2 including a plurality of quality control ingredients 21, 22, 23 24, and mixing, by the automated preparation device, the at least two quality control ingredients 21, 22, 23 24 in a sample preparation receptacle to obtain a quality control 31, 32, 33 which mimics the properties of a biological sample to be analyzed by the analyzer. The method can further include determining at least one parameter of the quality control and determining a status of the analyzer based on the determined parameter of the quality control 31, 32, 33.

In the example of FIG. 1, three different examples of quality controls 31, 32, 33 are shown. It can be seen that each quality control 31, 32, 33 can include a matrix 31A, 32A, 33A (e.g., a matrix solution) respectively, a modifying agent 31B, 32B, 33B respectively and a reagent 31C, 32C, 33C or a diluent 33D. The composition of the quality controls 31, 32, 33 of FIG. 1 is purely illustrative. As explained above, a quality control can also include none or two or more different types of modifying agents. In addition or alternatively, a quality control can include none or two or more different types of matrices. In addition or alternatively, a quality control can include none or two or more different types of reagents and/or diluents.

In the following passages, examples of preparing quality controls in a liquid state from quality control ingredients in a liquid form will be discussed. However, the techniques for preparing quality controls can equally be applied to prepare quality controls which can be gaseous or solid, or handle quality control ingredients in a gaseous or solid form. For example, a test strip to which a modifying agent and a matrix can be applied could be a quality control. In addition or alternatively, the quality control ingredients can be stored in the quality control ingredient repository in a solid and a gaseous form.

Returning to the example of FIG. 1, the first quality control 31 and the second quality control 32 may be liquid mixtures of the different quality control ingredients. The first quality control 31 can be a quality control required to monitor the performance of an analyzer when carrying out a first test or assay. Accordingly, the second quality control 32 can be a quality control required to monitor the performance of an analyzer when carrying out a second test or assay.

As can be seen, the first and second quality controls 31, 32 can contain the same type of matrix solution 31A, 32A (e.g., blood serum or blood plasma) and the same type of reagent 31C, 32C. However, the modifying agents 31B, 32B of the first and second quality controls 31, 32 can differ. The third quality control 33, on the other hand, can include the same type of modifying agent 33B as the first quality control 31 but a different type of matrix solution 33A.

Accordingly, the quality control ingredient repository 2 can include matrix solutions 21, modifying agents 22, diluents 23 and reagents 24 which can be combined in different ways to prepare different quality controls in the analyzer. For example, different types of quality controls can be prepared by combining a set of quality control ingredients 21, 22, 23, 24 in different ways. In addition or alternatively, multiple instances of the same type of quality control can be prepared by using the same quality control ingredients from the quality control ingredient repository 2 multiple times. In this manner, a comparatively small stock of quality control ingredients can suffice to prepare a large variety of quality controls.

Further details regarding the methods for monitoring the performance of an analyzer for biological samples will be discussed below in connection with FIG. 4a to FIG. 10. Next, automated analyzers for biological samples according to the present disclosure will be discussed in connection with FIG. 2 and FIG. 3.

FIG. 2 is a schematic representation of an automated analyzer 1 for analyzing biological samples including a repository 2 for storing a plurality of quality control ingredients 21, 22, 23, 24 for preparing quality controls, an automated preparation device 5 configured to, after receipt of the instruction that a monitoring procedure shall be executed, obtain at least two quality control ingredients 21, 22, 23, 24 from the repository 2 and mix the at least two quality control ingredients 21, 22, 23, 24 in a sample preparation receptacle 3 to obtain a quality control which mimics the properties of a biological sample to be analyzed by the analyzer and a measurement device 4 configured to determine at least one parameter of the quality control and to determine a status of the analyzer based on the determined parameter of the quality control.

In the example of FIG. 2, the analyzer 1 can also include a controller 6 which can be configured to control the quality control preparation and analysis process. In particular, the controller 6 can control the operation of the quality control ingredient repository 2, the preparation device 5, and the measurement device 4. In other examples, the controller 6 can be external to the analyzer 1 (e.g., a controller arranged remotely from the analyzer 1). For instance, a central controller can be provided in a laboratory to control multiple analyzers and other pieces of laboratory equipment.

The controller 6 can be configured to control the different devices of the analyzer 1 to carry out the operations according to any one of FIG. 4a to FIG. 10.

The additional devices of the analyzer 1 will be discussed below.

The preparation device 5 can be any device of an analyzer configured to automatically handle or prepare biological samples or reagents in the analyzer 1. In the following sections, a pipettor can be used as example automated preparation device. However, in other examples the automated preparation device 5 can have different forms. For instance, the automated preparation device can include a robotic gripper adapted to manipulate the quality control ingredients. In still other examples, an automated preparation device can be a dispenser or a sprayer configured to dispense quality control ingredients into a sample preparation receptacle. As can be seen, the automated preparation device can have many different forms.

In the example where the automated preparation device 5 includes a pipettor, the pipettor can be configured to sample a quality control ingredient 21, 22, 23, 24 from a container of the quality control ingredient repository 2 and dispense the quality control ingredient 21, 22, 23, 24 into the sample preparation receptacle 3. In the same manner, the pipettor can be configured to sample a second quality control ingredient 21, 22, 23, 24 (and optionally one or more additional quality control ingredient 21, 22, 23, 24) from the quality control ingredient repository 2 and dispense it into the sample preparation receptacle 3. In this manner, a quality control for a particular test and assay of the analyzer can be mixed in the sample preparation receptacle 3.

In some examples, the pipettor 5 (or other automated preparation device) can be a dedicated device for preparing quality controls. In other examples, the pipettor 5 can be a pipettor of the analyzer configured to automatically handle biological samples which can be analyzed in the analyzer and/or reagents used in the analysis processes. In other words, an automated pipettor 5 of the analyzer can have a dual use for sample preparation and quality control preparation.

In some examples, the automated pipettor can include a plurality of pipette heads. A first pipette head or group of the pipette heads can be configured to handle biological samples and/or reagents to be used in the analysis process. A second pipette head or group of pipette heads can be used to handle quality controls and/or quality control ingredients.

In addition or alternatively, the pipettor can be configured to avoid that the same pipette head is used for handling a particular combination of biological samples and/or reagents and quality control ingredients (in order to avoid contamination of samples or quality controls or to ensure that a quality control can be prepared independently of the measurement process).

In addition or alternatively, the pipettor can be configured to use disposable or washable pipette tips to handle the quality control ingredients. In this manner, the same pipette head can be employed to handle different substances.

Even though the above discussion explained different properties of an automated sample preparation device 5 using a pipettor as an example, alternative automated preparation devices can also have the above discussed features (unless they are specific for a pipettor).

The quality control ingredient repository 2 will be discussed next. As shown in FIG. 2, the quality control ingredient repository 2 can be internal to the analyzer 1 whose performance can be monitored by the quality controls prepared using the quality control ingredients 21, 22, 23, 24 stored therein. However, in other examples, the quality control ingredient repository 2 can be located externally to the analyzer (and can be accessible by the automated preparation device 5). For instance, multiple analyzers can share a single quality control ingredient repository 2.

The quality control ingredient repository 2 can include a plurality of different quality control ingredients 21, 22, 23, 24 required for the preparation of a variety of different quality controls (see, e.g., the example quality controls discussed above and below in connection with FIG. 4a to FIG. 10). In other examples, the quality control ingredient repository 2 can be configured to include only the quality control ingredients 21, 22, 23, 24 required for preparing one particular quality control (e.g., a quality control required for a subsequent monitoring procedure). In the same manner, the quality control ingredient repository 2 can be configured to include only the quality control ingredients 21, 22, 23, 24 required for preparing two or more particular quality controls required for a subsequent monitoring procedure.

In some examples, the quality control ingredient repository 2 can be integral part of a repository also holding reagents used in analysis procedures on biological samples in the analyzer. In these examples, the automated preparation device 5 can handle the quality control ingredients in the same manner as the reagents.

A short discussion of the configuration of the quality control ingredient repository 2 will be given next. In general, the quality control ingredients 21, 22, 23, 24 can be stored in the quality control ingredient repository 2 in any suitable form. In some examples, at least some of the quality control ingredients 21, 22, 23, 24 can be stored in the quality control ingredient repository 2 in a liquid form. For instance, at least some of the matrices 21 can be stored in the quality control ingredient repository 2 as matrix solutions 21A, 21B. In other examples, the matrices 21 can be stored in the quality control ingredient repository 2 in a lyophilized form. Matrices in a lyophilized form can be brought into a liquid form (reconstituted) by adding another quality control ingredient, e.g. a diluent 23, as part of the sample preparation process.

In addition or alternatively, modifying agents 22 can be stored in a liquid form in the quality control ingredient repository 2.

The quality control ingredients 21, 22, 23, 24 can be contained in any suitable receptacle (e.g., a container, a can, a cuvette, a tube, a cartridge or a bottle). In one example, the receptacle can be disposable and contain a particular quality control ingredient for preparing one or more instances of a particular quality control (e.g., a disposable container, can, cuvette, tube, cartridge or bottle). In other examples, a disposable receptacle can contain a set of quality control ingredients for preparing one or more instances of a particular quality control.

In still other examples, the quality control ingredients can be provided as a kit of receptacles (e.g., disposable receptacles) including quality control ingredients (e.g., all quality control ingredients) required for a particular type of monitoring procedure. In other examples, the quality control ingredients can be provided as a kit of receptacles (e.g., disposable receptacles) including quality control ingredients (e.g., all quality control ingredients) required for a particular group of monitoring procedures. For example, a kit may include one or more receptacles including one or more matrices (e.g., in liquid or lyophilized form) and one or more modifying agents needed to prepare one or more quality controls for one or more monitoring procedures of an analyzer. The kit of receptacles can also include directions for use of the items of the kit.

In other examples, the quality control ingredients can be provided in the same type of receptacles as the reagents used in the analyzer in the course of the analysis processes carried out by the analyzer.

As shown in FIG. 2, the automated preparation device 5 can dispense the quality control ingredients into the sample preparation receptacle 3. The sample preparation receptacle 3 can have any suitable form for preparing the quality controls. For instance, the sample preparation receptacle 3 can be a cuvette, a tube, a dish or a bowl. In still other examples, the preparation receptacle 3 can be a substrate on which quality control ingredients can be mixed (e.g., a microscope slip or test strip or another substrate).

The sample preparation receptacle 3 can be a disposable sample preparation receptacle in some examples. In other examples, the sample preparation receptacle 3 can be reusable (e.g., washable).

In the example of FIG. 2, the sample preparation receptacle 3 can be at the same time a test receptacle. This can mean that the measurement device 4 can determine one or more parameters of the quality control while the quality control can be contained in the sample preparation receptacle 3. Other examples will be discussed in connection with FIG. 3 below.

In one example, the sample preparation receptacle 3 can be placed at the same position as a receptacle for biological samples to be analyzed. In these examples, the measurement device 4 can determine one or more parameters of the quality control in the same setup which is used for analyzing biological samples.

For instance, an analyzer might include a plurality of cuvettes (or other receptacles) into which biological samples and/or reagents can be dispensed by the automated preparation device 5. In one example, the analyzer 1 can be configured to prepare one or more quality controls as described in one or more of the plurality of cuvettes (or other receptacles). Subsequently, the measurement device can be used to determine one or more parameters of the quality controls.

The measurement device 4 will be shortly discussed in the following passage. In general, the nature of the measurement device 4 may be immaterial for the techniques. The methods for monitoring the performance of an analyzer can be carried out regardless of the nature of the measurement device 4.

In some examples, the measurement device 4 can be an optical measurement device. For example, the measurement device 4 can be a photometer configured to determine at least one parameter of the quality control by a transmission and/or reflectance measurement. In addition or alternatively, the measurement device 4 can be an optical measurement device configured to collect fluorescent light from the quality control to determine one or more parameters of the quality control. In still other examples, the measurement device 4 can include one or more cameras configured to take images of the quality control. The measurement device 4 can then determine one or more parameters of the quality control based on the images taken by the one or more cameras.

After a first example analyzer has been discussed in connection with FIG. 2, a variant of the analyzer of FIG. 2 will subsequently be discussed in connection with FIG. 3. Several elements are identical in the analyzers of FIG. 2 and FIG. 3. The description of these elements will not be repeated. The difference between the analyzers of FIG. 2 and FIG. 3 is that the analyzer 1′ of FIG. 3 can include a sample preparation receptacle 3 separate from a sample measurement receptacle 7. The sample preparation receptacle 3 can be used as described in connection with FIG. 2 above to prepare quality controls.

However, the quality controls can then be transferred into the sample measurement receptacle 7 to determine one or more parameters of a respective quality control. In some examples, one or more reagents can be added (e.g., by the automated sample preparation device) to the sample measurement receptacle 7. In still other examples, a quality control can be prepared in a quality control ingredient receptacle and then transferred to be used in a monitoring procedure. For instance, a particular quality control ingredient receptacle can include a first quality control ingredient. Then, one or more additional quality control ingredients can be added by the preparation device to prepare a quality control. This quality control can then be transferred to a sample measurement receptacle.

In one example, the sample preparation receptacle 3 can include a plurality of receptacles (e.g., cups or cuvettes) in which a set of quality controls can be prepared at the same time (or sequentially). For instance, a first quality control can include a matrix solution but no modifying agent (e.g., a “normal” quality control). A second quality control can include the same matrix solution and a first predetermined quantity of a modifying agent (e.g., a first “abnormal” quality control). In addition, a third quality control can include a second predetermined quantity of the modifying agent larger than the first quantity (e.g., a second “abnormal” quality control). The analyzer can be configured to determine one or more parameters of all three quality controls on a monitoring procedure.

In another example, the analyzer can be configured to prepare two or more quality controls including two or more differing concentrations of a diluent. Again, the analyzer can be configured to determine one or more parameters of the two or more quality controls on a monitoring procedure.

Additional aspects of how quality controls can be prepared and used in monitoring processes will now be discussed in connection with FIG. 4a to FIG. 10. In the examples of FIG. 4a to FIG. 10, the analyzer can be a coagulation analyzer using an optical measurement device. However, as already set out above, the analyzer can be any type of analyzer for biological samples and the measurement device can be any type of measurement device. The features described herein in connection with a coagulation analyzer having an optical measurement device in connection with FIG. 4a to FIG. 10 can also be applied to other types of analyzers (unless the respective features is specific to a coagulation analyzer). For instance, the analyzer can be an immunochemistry analyzer or a clinical chemistry analyzer.

FIG. 4a, FIG. 4b and FIG. 4c illustrates a first complex monitoring procedure (also referenced as ‘quality control run’ in connection with FIG. 4a to FIG. 10) including the preparation of different quality controls according to the present disclosure.

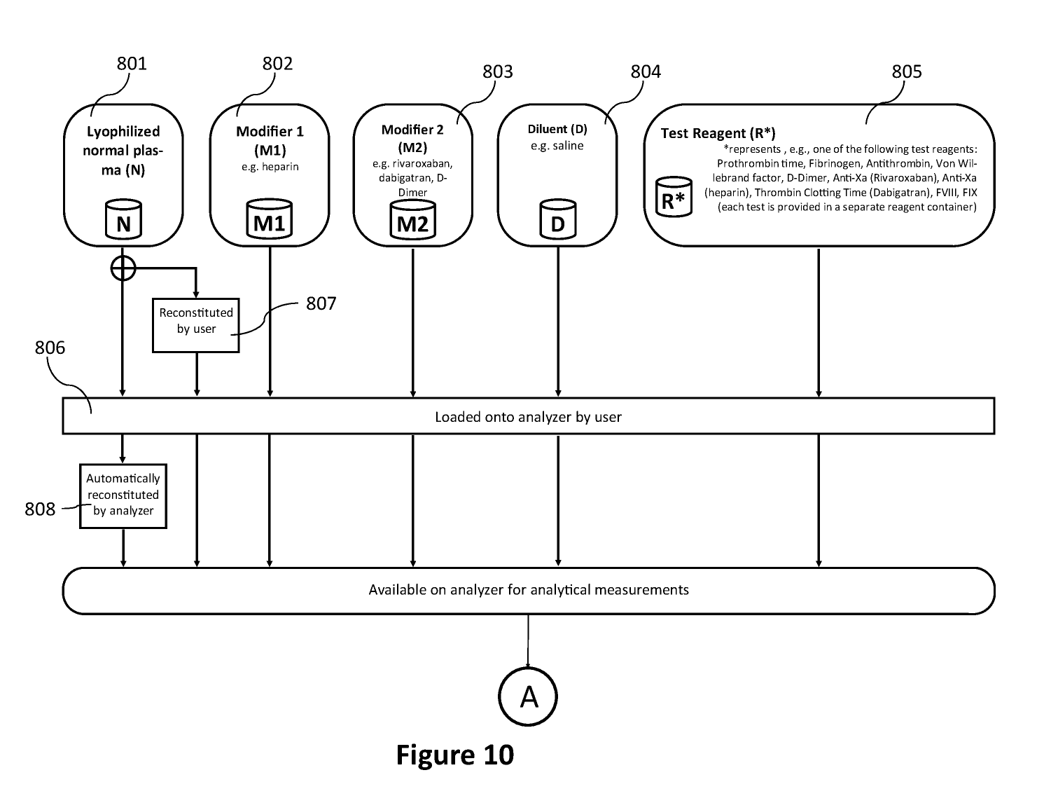

The process can start at 401 with an analyzer having a stocked control ingredient repository 2. Different aspects of the stocking process of the control ingredient repository 2 are discussed in connection with FIG. 10 below.

For the sake of illustration, in the example of FIG. 4a to FIG. 10, the control ingredient repository 2 can include the following quality control ingredients: Reconstituted normal blood plasma (e.g., taken from a healthy individual, labelled as ‘N’ in FIG. 4a, FIG. 4b, FIG. 7, FIG. 8 and FIG. 10) as matrix solution, a heparin solution as first modifying agent (labelled as ‘modifier 1’ or ‘M1’ in FIG. 4b, FIG. 7, FIG. 8 and FIG. 10), a solution containing rivaroxaban, dabigatran and D-dimer as second modifying agent (labelled as ‘modifier 2’ or ‘M2’ in FIG. 4b, FIG. 7, FIG. 8 and FIG. 10), a plurality of reagents for different tests or assays of the analyzer (i.e., for tests to determine or detect prothrombin time, aPTT, antithrombin, D-dimer, fibrinogen, thrombin clotting time, heparin anti-Xa activity, rivaroxaban anti-Xa activity, von Willebrand factors, factor VIII or factor IX, labelled as ‘R*’ in FIG. 4b, FIG. 7, FIG. 8 and FIG. 10) and saline as a diluent. However, the methods described below can be also used with any other suitable matrix, modifying agent, reagent and diluent and in particular the other matrices, modifying agents, reagents and diluents described.

At 402, a monitoring procedure (also referenced as quality control ‘QC’ in connection with FIG. 4a to FIG. 10) can be initiated. In the example of FIG. 4a, the monitoring procedure can be initiated at predefined points in time (in other words, the monitoring procedures can be started according to a schedule). For instance, the monitoring procedure can be started daily at a predetermined time or at multiple predetermined times each day (e.g., at 8 am, 2 pm and 10 pm in one example). Even though FIG. 4a to FIG. 4c describe initiating a particular monitoring procedure according to a schedule, this initiating technique can also be applied to all other monitoring procedures of the present disclosure.

As shown in FIG. 4a, the monitoring procedure can be initiated automatically by the analyzer at the scheduled time. Other techniques and trigger events will be discussed below.

The monitoring procedure of FIG. 4a to FIG. 4c can be designed to monitor the analyzer's performance when carrying out a plurality of tests or assays related to coagulation (i.e., tests or assays determining or detecting prothrombin time, aPTT, antithrombin, D-dimer, fibrinogen, thrombin clotting time, heparin anti-Xa activity, rivaroxaban anti-Xa activity, von Willebrand factors, factor VIII or factor IX).

The tests or assays related to coagulation can be split in three different groups 403, 404, 405: For each group of tests or assays 403, 404, 405 a ‘level 1 quality control run’ and a ‘level 2 quality control run’ can be performed. This will be discussed in more detail in connection with FIG. 4b and FIG. 4c.

Starting with FIG. 4b, a ‘level 1 quality control run’ can be performed by the analyzer. In the course of this monitoring procedure at 406, the automated sample preparation device (e.g., pipettor) of the analyzer can dispense the matrix solution and a respective reagent (e.g., a reagent for a test or assay to detect van Willebrand factors) in a test cuvette (‘test’ in FIG. 4b) to prepare a quality control. This preparation step can be executed in a similar manner as a preparation step of an actual biological sample to be analyzed by the analyzer.

In a further step 407, the analyzer can measure the coagulation time by using an optical detection method (e.g., a photometer). Thus, in the example of FIG. 4b, the coagulation time can be determined as parameter of the quality control. Again, the particular detection method can be immaterial for the methods discussed in connection with FIG. 4a to FIG. 10 and can be a different detection method (using a different measurement device) in other examples.

Subsequently, at 408, the analyzer can determine if the determined parameter of the quality control is in a predetermined range. In other examples, the analyzer can determine if the determined parameter lies above or below a predetermined threshold. In still other examples, the analyzer can determine if the parameter fulfills a predetermined criterion. In all examples, the predetermined ranges, thresholds or criteria can be selected to be indicative of a proper function of the analyzer.

For instance, coagulation time may be expected to lie with a predetermined range for biological samples. If coagulation time is out of this range, this can be indicative of an analyzer malfunction. This can be detected by monitoring procedures.

At 409, 410 and 411, depending on the result of the comparison of the detected parameter with the predetermined range, a status of the analyzer can be determined. In the example of FIG. 4a, the status can either be ‘valid’ if the parameter of the quality control lies within the predetermined range or ‘blocked’ if this not the case.

The consequences of this status determination can differ. In one example, an analyzer may continue with analyzing biological samples if all monitoring procedures yield that the status is valid. In other examples, the analyzer may continue with analyzing biological samples by using a particular test or assay if the monitoring procedures using corresponding quality controls yield that the status is valid. On the other hand, the analyzer may refrain from analyzing biological samples if one monitoring procedure yield that the status is blocked. In other examples, the analyzer may refrain from analyzing biological samples by using a particular test or assay if the monitoring procedures using corresponding quality controls yield that the status is blocked.

In addition or alternatively, the analyzer can prompt an error message to an operator if the status of the analyzer is set to a particular level (e.g., blocked). In addition or alternatively, the analyzer may initiate one or more self-diagnostic tests if the status of the analyzer is set to a particular level (e.g., blocked). In still other examples, the analyzer can initiate a predetermined set of further monitoring procedures if the status of the analyzer is set to a particular level (e.g., blocked).

In the examples of FIG. 4a to FIG. 10, the analyzer can have two different status levels. However, in other examples, the analyzer can have more than two status levels. For example, different status levels can indicate a degree of deviation from a predetermined range or a predetermined threshold. In other examples, different status level can indicate that a predetermined parameter is within a predetermined range or below/above a predetermined threshold but is within a predetermined margin of the boundaries of the range or the threshold. In still other examples, different status levels may indicate a degree of change compared to a previous monitoring procedure involving a particular quality control.

In addition or alternatively, a status of the analyzer may be general (e.g., for all tests or assays carried out by the analyzer) or may be set on a per-test or per-assay level.

Irrespective of the particular status levels, in response to setting the analyzer to a particular status level, different actions may be triggered. For instance, a status message may be prompted to an operator and/or additional self-diagnostic tests may be triggered.

Returning to FIG. 4a, the test procedure can cycle through the process described in FIG. 4a for a plurality of reagents used in the predetermined tests or assays of the analyzer. In a second sub-step of the monitoring procedure, the analyzer can perform level 2 quality control runs as shown in FIG. 4c. In general, while level 1 quality control runs only involved quality controls including a matrix solution and a reagent, the level 2 quality control runs can also involve quality controls to which modifying agents may be added.

As can be seen at 412, 413, 414, the preparation device of the automated analyzer can prepare different quality controls: a first quality control preparation process can involve adding a first modifying agent (M1) to the matrix solution, a second quality control preparation process can involve adding a second modifying agent (M2) to the matrix solution, and in a third quality control preparation process, a diluent (D) can be added to the matrix solution.

Each of these three quality controls can be mixed in a pre-dilution cuvette as sample preparation device (as described above in connection with FIG. 2 and FIG. 3). Subsequently, the quality control can be transferred to a test cuvette (or other suitable receptacle). While the quality controls are contained in a respective test cuvette, a reagent can be added by the automated preparation device.

In subsequent steps 415-419, each of the quality controls can undergo a parameter determination process and status determination process as discussed above for the level 1 quality control runs in connection with FIG. 4a. The analyzer status levels in response to the results of the measurements on the level 2 quality controls can be the same ones or different ones than the levels in response to the results of the measurements on the level 1 quality controls.

The analyzer can perform level 2 quality control run for each test or assay in the predetermined set of tests and assays and then can conclude the monitoring procedure. At a subsequent scheduled time, the monitoring procedure can be initiated anew.

As already discussed, the monitoring procedures of the present disclosure can be varied in different ways. In connection with FIG. 5a and FIG. 5b, examples of such variations will be discussed in the subsequent passages.

The monitoring procedure of FIG. 5a and FIG. 5b can include a first set 502 of tests or assays (see FIG. 5a) for which a monitoring procedure can be initiated according to a schedule or at predefined points in time. In one example, the first set 502 of tests or assays can include tests or assays which are more frequently performed on the analyzer (e.g., screening tests) than other tests or assays (e.g., specific tests in the course of a particular diagnostic or therapeutic procedure). The monitoring procedure of the first set of tests or assays can be initiated 501 at a predetermined point in time. In some examples, the analyzer can then run through the monitoring procedures described in connection with FIG. 4a to FIG. 4c.

In addition, the monitoring procedure of FIG. 5a and FIG. 5b can include a second set 505 of tests or assays (see FIG. 5b) for which a monitoring procedure can be initiated on demand or upon receipt of a predetermined trigger event. For instance, the trigger event can be detection 504 that a particular test or assay can be executed by the analyzer (or that a particular biological sample can be provided to the analyzer).

In other examples, a trigger event can be a user command that a particular monitoring procedure can be carried out. In still other examples, a trigger event can be detection that a particular reagent is stored on the analyzer or that a new lot of reagents is stored on the analyzer. These trigger events may not be limited to those used in the particular method of FIG. 5a and FIG. 5b but can also be applied in all other monitoring procedures.

In an optional step 506, the analyzer can determine if a valid result of a monitoring procedure is available for the particular test or assay. For instance, a valid result of a monitoring procedure can include a result of a monitoring procedure for the particular test or assay which is not older than a predetermined threshold time. If a valid result of a monitoring procedure is available for the particular test or assay, the monitoring procedure can end 508 (and, e.g., the biological sample can be analyzed by the analyzer).

If no valid result of a monitoring procedure is available for the particular test or assay, a monitoring procedure can be initiated for the particular test or assay 507 (e.g., the monitoring procedure described in connection with FIG. 4a to FIG. 4b or another monitoring procedure). Depending on the result of the monitoring procedure, a status of the analyzer can be set accordingly.

A further example monitoring procedure is illustrated in connection with FIG. 6 to FIG. 8. In this example, the analyzer can initiate a monitoring procedure at a predetermined point in time 601. Then, the analyzer can carry out for a particular set of tests or assays the monitoring procedures described in connection with FIG. 4a to FIG. 4c 602, 603.

Additionally, the monitoring procedure of FIG. 6 to FIG. 8 can include a level 3 quality control run (see FIG. 7) and a level 4 quality control run (see FIG. 8). Both the level 3 quality control run and the level 4 quality control run can be performed by the analyzer in a similar manner as the level 2 quality control run described in connection with FIG. 4c above. However, an amount of modifying agents and diluent added to the quality control can be different for a respective level 2, 3 and 4 quality control run. For instance, an amount of modifier added may be lower for a level 2 quality control run, higher for a level 3 quality control run and still higher for a level 4 quality control run. In addition, a diluent concentration may be varied between the different quality control runs.

In general, monitoring procedures may include any number and/or combination of quality control runs in the methods. For instance, a concentration of one or more modifying agents can be varied in a plurality of quality controls (e.g., in four or more or five or more quality controls). In addition or alternatively, two or more modifying agents or matrices can be combined in one or more different combinations.

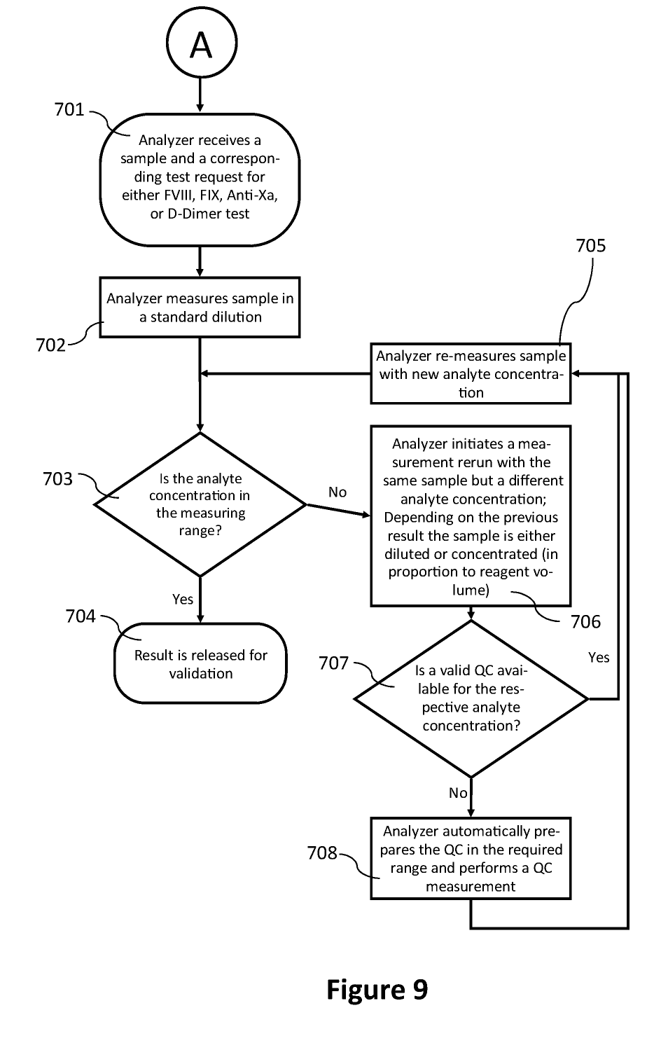

FIG. 9 depicts still another monitoring procedure. In the example of FIG. 9, the monitoring procedure can be triggered by detecting 703, 706 that a parameter measured on a biological sample is out of a predetermined range (or below or above a predetermined threshold).

In one example, the process can start with the receipt 701 of a particular test or assay request. In a first optional step 702, the analyzer can measure a parameter of the biological sample using a first set of measurement parameters (e.g., a first dilution level of the biological sample).

In a subsequent step 703, the analyzer can determine a particular parameter of the biological sample and determine if the parameter meets a predetermined criterion (e.g., lies within a predetermined range or below or above a predetermined threshold). If this is the case, the measurement result can be released at 704.

However, if the parameter of the biological sample does not meet the predetermined criterion, the analyzer can carry out one or more additional measurements 706 on the biological sample with a second set of measurement parameters different from the first set of measurement parameters. For instance, the analyzer can dilute or concentrate the biological sample and rerun the measurement.

In a further optional step 707, the analyzer can determine if a valid quality control result is available for the second set of measurement parameters (e.g., as explained in connection with step 506 in FIG. 5b above). If this is the case, the analyzer can rerun the test or assay with the second set of measurement parameters 705.

However, if this is not the case, the analyzer can perform a monitoring procedure for the particular test or assay at step 708. Depending on the result of this monitoring procedure and the status of the analyzer, the analyzer may then proceed to rerunning the test or assay on the biological sample. This can conclude the method of FIG. 9.

In general, all monitoring procedures can be performed automatically (i.e., without user intervention) unless an intervention of a user is explicitly mentioned (e.g., a user initiating a particular monitoring procedure). In particular, the preparation of the quality controls required in the monitoring procedures can be performed automatically by an analyzer in the methods of the present disclosure.

All automated techniques can be encoded in instructions on a computer-readable medium or in an electronic signal. The computer-readable medium or the electronic signal can include instructions which when executed by a controller of an analyzer can cause an analyzer to perform the operations of the methods described herein.

In some examples, an automated analyzer may already be equipped with the hardware required to carry out the monitoring procedures of the present disclosure. In this situation, the analyzer can be empowered to carry out the monitoring procedures of the present disclosure by a software or firmware update.

Last, in connection with FIG. 10, a process of stocking a quality control ingredient repository according to the present disclosure will be discussed. As already described in detail, different matrices 801, modifying agents 802, 803, diluents 804 and reagents 805 can be stored in a quality control ingredient repository.

In some examples, one or more of the quality control ingredients can be shipped in a preconditioned form (e.g., in lyophilized form). In this situation, the quality control ingredients can be prepared for use in the analyzer by a user 807 or by the analyzer itself 808.

In one example, the analyzer can be configured to reconstitute a lyophilized quality control ingredient 808 (e.g. to bring a particular matrix in a liquid form).

After the quality control ingredients have been loaded 806 into an analyzer (by a user or automatically by a feeding storing device), the analyzer can perform the monitoring procedures of the present disclosure.

In the preceding detailed description multiple examples of optical measurement devices and methods of the present disclosure have been discussed. However, the optical measurement devices and methods of the present disclosure can also be configured as set out in the following.

A method for monitoring the performance of an analyzer for biological samples having an automated preparation device is presented. The method can comprise receiving an instruction that a monitoring procedure shall be executed; after receipt of the instruction that a monitoring procedure shall be executed; obtaining, by the automated preparation device, at least two quality control ingredients from a repository including a plurality of quality control ingredients and mixing, by the automated preparation device, the at least two quality control ingredients in a sample preparation receptacle to obtain a quality control which mimics the properties of a biological sample to be analyzed by the analyzer. The method further can comprise determining at least one parameter of the quality control and determining a status of the analyzer based on the determined parameter of the quality control.

The at least two quality control ingredients can include one or more matrix solutions and one or more modifying agents. The matrix solution can be derived from a bodily fluid or a constituent of a bodily fluid or the matrix solution can be an artificial substance mimicking properties of a bodily fluid or a constituent of a bodily fluid. The matrix solution can be derived from blood plasma or blood serum or is an artificial substance mimicking properties of blood plasma or blood serum. The matrix solution can be lyophilized.

The one or more modifying agents can include one or more of a drug, a metabolite of a drug, a substance that accumulates in a predetermined medical or metabolic condition, a substance that is normally not present in a bodily fluid, and a substance that is normally present in a bodily fluid.

The one or more modifying agents can include one or more of heparin, hirudin, rivaroxaban, dabigatran, D-dimer, prothrombin, drugs or drug metabolites, enzymes, growth hormones, immunosuppressants, proteins, inflammation markers, substrates such as albumin, bilirubin, creatinine and disease markers.

The method can further comprise adding a diluent or a reagent to the sample preparation receptacle by the automated preparation device. The diluent can include one or more of water or a salt solution.

The method can further comprise adding a stabilizing agent to the sample preparation receptacle by the automated preparation device.

The quality control can mimic a biological sample of a healthy donor, a biological sample of a patient who is subject to a predetermined medical or metabolic condition, or a biological sample of a patient who has ingested a predetermined drug or other substance.

A monitoring procedure can include determining at least one parameter of one quality control.

A monitoring procedure can include determining at least one parameter of two or more quality controls.

The repository can include a plurality of quality control ingredients is part of the analyzer. The repository can include one or more containers. Each container can include quality control ingredients required to prepare one or more instances of a particular quality control. The container can be a disposable container including the quality control ingredients required for a single quality control. The repository can include one or more containers that can include quality control ingredients that can be used for preparing two or more different types of quality controls.

At least one of the quality control ingredients can be stored in a liquid form.

The method can further include mixing the at least two quality control ingredients in a sample preparation receptacle to obtain a further quality control in addition to the previously prepared quality control which can mimic the properties of a biological sample to be analyzed by the analyzer having different properties than the previously prepared quality control sample, determining at least one parameter of the further quality control, and determining a status of the analyzer based on the determined parameters of the previously prepared and further quality controls.

The previously prepared and further quality controls share at least one common matrix solution or at least one common modifying agent. The previously prepared and further quality controls can include at least one different matrix solution or at least one different modifying agent.

The method can further comprise receiving an instruction that a second monitoring procedure shall be executed, after receipt of the instruction that a second monitoring procedure shall be executed, obtaining, by the automated preparation device, at least two further quality control ingredients from the repository and mixing, by the automated preparation device, the at least two further quality control ingredients in a sample preparation receptacle to obtain a further quality control in addition to the previously prepared quality control which can mimic the properties of a biological sample to be analyzed by the analyzer. The method can further comprise determining at least one parameter of the further quality control and determining a status of the analyzer based on the determined parameter of the further quality control.

The previously prepared and further quality controls can share at least one common matrix solution or at least one common modifying agent. The previously prepared and further quality controls can include at least one different matrix solution or at least one different modifying agent.

The monitoring procedure can be carried out according to a predetermined schedule. The monitoring procedure can be carried out periodically.

The monitoring procedure can be carried out upon receipt of a trigger event. The trigger event can include determining that a predetermined type of biological sample is to be analyzed by the analyzer, that a particular test procedure is to be carried out by the analyzer, that a new lot of reagents is placed in the analyzer and that a particular measurement result has been measured by the analyzer. The determining that a particular measurement result has been measured by the analyzer can include determining that a measurement result measured by the analyzer is out of a predetermined range.

The method can further comprise automatically generating the instruction that a monitoring procedure shall be executed in reply to a trigger event or at a predefined time.

The obtaining, preparing and determining steps can be carried out automatically by the analyzer.

The determining a status of the analyzer based on the determined parameter of the quality control can include comparing the determined parameter with a predefined target parameter.

The status of the analyzer can include one of a clear status in which the analyzer is ready to analyze a biological sample and a fault status in which the analyzer is not ready to analyze a biological sample. The analyzer can be set to a fault status if the determined parameter of the quality control deviates from a target parameter or target parameter range.

The method can further comprise preparing one or more further quality controls. The first quality control and the one or more further quality controls can include varying proportions of one or more modifying agents. The first quality control can include a predetermined quantity of a modifying agent so that the at least one parameter of the first quality control lies in an abnormal range and a second quality control of the one or more further quality controls include a higher or lower quantity of the modifying agent than the first quality control so that the at least one parameter of the second quality control also lies in an abnormal range.

The method can further comprise preparing one or more further quality controls. The first quality control and the one or more further quality controls can include the same modifying agents but different matrix solutions.

The method can further comprise preparing one or more further quality control samples. The first quality control and the one or more further quality control samples can include varying proportions of a diluent.

The analyzer can be an immunochemistry analyzer, a clinical chemistry analyzer, or a coagulation analyzer.

The preparation device can include a pipetting system including one or more pipettors.

The preparation device can also be used to prepare samples to be analyzed in the analyzer.

The method can further comprise transferring the quality control from the sample preparation receptacle to an analyzing receptacle of the analyzer. The at least one parameter of the quality control can be determined when the quality control is in the analyzing receptacle.

The determining the step of determining at least one parameter of the quality control can take place when the quality control is contained in the sample preparation receptacle.

The analyzer can include a plurality of sample preparation receptacles for preparing quality controls.

The method can further comprise adding one or more reagents to the quality control before determining the at least one parameter of the quality control.

The automated preparation device can include dedicated handlers for preparing the quality controls which may not be used for handling the biological samples to be analyzed in the analyzer.

A method for monitoring the performance of an analyzer for biological samples having an automated preparation device is presented. The method can comprise receiving an instruction that a monitoring procedure shall be executed, upon receipt of the instruction that a monitoring procedure shall be executed, by the automated preparation device obtaining one or more matrix solutions from a repository including a plurality of quality control ingredients; obtaining one or more modifying agents from the repository including a plurality of quality control ingredients; and mixing at least the one or more matrix solutions and the one or more modifying agents in a sample preparation receptacle to prepare a quality control sample which mimics the properties of a biological sample to be analyzed by the analyzer. The method can further comprise determining at least one parameter of the quality control sample and setting a status of the analyzer to a fault status if the at least one parameter deviates from a target parameter range.

An automated analyzer for analyzing biological samples is presented. The automated analyzer can comprise a repository for storing a plurality of quality control ingredients for preparing quality controls, an automated preparation device configured to, after receipt of the instruction that a monitoring procedure shall be executed, obtain at least two quality control ingredients from the repository including a plurality of quality control ingredients and mix the at least two quality control ingredients in a sample preparation receptacle to obtain a quality control which mimics the properties of a biological sample to be analyzed by the analyzer, and a measurement device configured to determine at least one parameter of the quality control and to determine a status of the analyzer based on the determined parameter of the quality control.

The automated preparation device can be configured to prepare a plurality of different types quality controls which mimic the properties of a plurality of different types of biological samples to be analyzed by the analyzer by using the plurality of quality control ingredients.

The preparing a plurality of different quality controls can include re-using at least one constituent for two or more different quality control samples.

The repository can include one or more containers. Each container can include quality control ingredients required to prepare a particular quality control. The container can be a disposable container including the quality control ingredients required for a single quality control or more than one quality control to be used in a single monitoring procedure.

The repository can include one or more containers that can include quality control ingredients that can be used for preparing two or more different types of quality controls. The repository can include one or more containers that can include quality control ingredients that can be used for preparing two or more quality controls of the same type.

The analyzer can be an immunochemistry analyzer, a clinical chemistry analyzer, or a coagulation analyzer.

The preparation device can also be configured to prepare samples to be analyzed in the analyzer. The preparation device can include a pipetting system including one or more pipettors. The preparation device can include one or more pipettors exclusively for preparing the quality controls. The preparation device can be configured to use at least one disposable pipette tip for mixing the quality controls.

The automated analyzer can further comprise a transfer device configured to transfer the quality control from the sample preparation receptacle to an analyzing receptacle of the analyzer. The analyzer can be configured to determine the at least one parameter of the quality control when the quality control is in the analyzing receptacle.

The analyzer can include a plurality of sample preparation receptacles for preparing quality controls. The analyzer can include a measurement device such as, for example, an optical measurement device such as, for example, a photometer.

A computer readable medium is presented. The computer readable medium can have instructions stored thereon which when executed by a controller of an analyzer for biological sample can cause the analyzer for biological samples to perform the steps of the above methods.

A kit of disposable receptacles for performance monitoring of an analyzer for biological samples having an automated preparation device is presented. The kit can include one or more receptacles including one or more matrices derived from a bodily fluid or a constituent of a bodily fluid, or being an artificial substance mimicking properties of a bodily fluid or a constituent of a bodily fluid; and one or more modifying agents including one or more of a drug, a metabolite of a drug, a substance that accumulates in a predetermined medical or metabolic condition, a substance that is normally not present in a bodily fluid, and a substance that is normally present in a bodily fluid.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A method for monitoring the performance of an analyzer for biological samples having an automated preparation device, the method comprising:
receiving an instruction that a monitoring procedure shall be executed;
after receipt of the instruction that a monitoring procedure shall be executed,
obtaining, by the automated preparation device, at least two quality control ingredients from a repository including a plurality of quality control ingredients, and
mixing, by the automated preparation device, the at least two quality control ingredients in a sample preparation receptacle to obtain a quality control which mimics the properties of a biological sample to be analyzed by the analyzer;
determining at least one parameter of the quality control; and
determining a status of the analyzer based on the determined parameter of the quality control.

2. The method according to claim 1, wherein the at least two quality control ingredients include one or more matrices and one or more modifying agents.

3. The method according to claim 2 wherein the matrix is derived from a bodily fluid or a constituent of a bodily fluid.

4. The method according to claim 2, wherein the matrix is an artificial substance mimicking properties of a bodily fluid or a constituent of a bodily fluid.

5. The method according to claim 2, wherein the matrix is derived from blood plasma, or blood serum, or is an artificial substance mimicking properties of blood plasma or blood serum.

6. The method according to claim 2, wherein the one or more modifying agents include one or more of: a drug, a metabolite of a drug, a substance that accumulates in a predetermined medical or metabolic condition, a substance that is normally not present in a bodily fluid, and/or a substance that is normally present in a bodily fluid.

7. The method according to claim 1, further comprises,
mixing the at least two quality control ingredients in a sample preparation receptacle to obtain a further quality control in addition to the previously prepared quality control which mimics the properties of a biological sample to be analyzed by the analyzer and has different properties than the previously prepared quality control;
determining at least one parameter of the further quality control; and
determining a status of the analyzer based on the determined parameters of the further and previously prepared quality controls.

8. The method according to claim 7, wherein the further and previously prepared quality controls share at least one common matrix or at least one common modifying agent.

9. The method according to claim 7, wherein the further and previously prepared quality controls include at least one different matrix or at least one different modifying agent.

10. The method according to claim 1, wherein the monitoring procedure is carried out according to a predetermined schedule.

11. The method according to claim 1, wherein the monitoring procedure is carried out upon receipt of a trigger event.

12. The method according to claim 12, wherein the trigger event comprises determining: that a predetermined type of biological sample is to be analyzed by the analyzer, that a particular test procedure is to be carried out by the analyzer, that a new lot of reagents is placed in the analyzer and/or that a particular measurement result has been measured by the analyzer.

13. The method according to claim 1, wherein the obtaining, preparing and determining steps are carried out automatically by the analyzer.

14. The method according to claim 1, wherein the analyzer is set to a fault state if the determined parameter of the quality control deviates from a target parameter or target parameter range.

15. An automated analyzer for analyzing biological samples, the automated analyzer comprising:
a repository for storing a plurality of quality control ingredients for preparing quality controls;
an automated preparation device configured to, after receipt of the instruction that a monitoring procedure shall be executed, obtain at least two quality control ingredients from the repository including a plurality of quality control ingredients and mix the at least two quality control ingredients in a sample preparation receptacle to obtain a quality control which mimics the properties of a biological sample to be analyzed by the automated analyzer; and
a measurement device configured to determine at least one parameter of the quality control and to determine a status of the automated analyzer based on the determined parameter of the quality control.

16. The automated analyzer according to claim 15, wherein the repository includes one or more containers including quality control ingredients required to prepare a particular quality control.

17. The automated analyzer according to claim, 15, wherein the automated preparation device includes a pipetting system comprising one or more pipettors.

18. A computer readable medium having instructions stored thereon which when executed by a controller of an analyzer for biological samples causes the analyzer for biological samples to perform the steps of the method of claim 1.
